(19) United States
(12) Patent Application Publication
(10) Pub. No.: US 2015/0354274 A1
(43) Pub. Date: Dec. 10, 2015

(54) ELECTRIC CURTAIN WITH HIDING MECHANISM

(71) Applicant: ARLINEA INDUSTRIES CO., Tao-Yuan (TW)

(72) Inventor: Yu-Heng YU, Tao-Yuan (TW)

(21) Appl. No.: 14/632,750

(22) Filed: Feb. 26, 2015

(30) Foreign Application Priority Data
Jun. 9, 2014 (TW) 103210144

(51) Int. Cl. E06B 9/68

(52) U.S. Cl. CPC E06B 9/68

(57) ABSTRACT

An electric curtain with a hiding mechanism provided for driving a curtain body includes a curtain rod (1) with a front side (111) and a back side (112) opposite to each other, and having at least two driven wheels (12) installed in a curtain rod (1), and a belt (13) wound around the at least two driven wheels (12), and the curtain body being installed to the curtain rod (1) and driven by the belt (13) and a driving device (2) installed to the back side (112) of the curtain rod (1) and hidden by the curtain body and provided for driving the belt (13) to move. The driving device (2) is hidden to improve the overall aesthetic appearance of the electric curtain.

### FIELD OF THE INVENTION

The technical field of the present invention relates to electric curtains, and more particularly to an electric curtain with a hiding mechanism provided for hiding ugly driving devices.

### BACKGROUND OF THE INVENTION

In general, an electric curtain is installed to an inner wall of a window of a building, and the electric curtain comes with an electric motor for controlling, opening, or shutting a curtain body of the electric curtain.

However, components such as the electric motor and gears of the conventional electric curtain are installed at an end of a curtain rod. Even though the curtain body covers the whole window, the components including the electric motor and gears installed at an end of the curtain rod are not covered. The exposed components look awkward and affect the overall appearance of the conventional electric curtains.

In view of the aforementioned drawback of the prior art, the inventor of the present invention based on years of experience in the related industry to conduct extensive researches and experiments, and finally designed a feasible solution to overcome the drawbacks of the prior art.

### SUMMARY OF THE INVENTION

Therefore, it is a primary objective of the present invention to provide an electric curtain with a hiding mechanism, wherein a driving device is installed at the back side of a curtain rod and covered by a curtain body. Therefore, the driving device is hidden to improve the overall aesthetic appearance of the electric curtain.

To achieve the aforementioned and other objectives, the present invention provides an electric curtain with a hiding mechanism for driving a curtain body, and the electric curtain comprises: a curtain rod, having a front side and a back side opposite to each other, at least two driven wheels installed in the curtain rod, and a belt wound around at least two driven wheels, wherein the curtain body is installed to the curtain rod and driven by the belt; and a driving device, installed to the back side of the curtain rod and hidden by the curtain body, and provided for driving the belt.

Compared with the prior art, the present invention has effect of hiding the driving device to improve the overall aesthetic appearance of the electric curtain.

### BRIEF DESCRIPTION OF THE DRAWINGS

FIG. 1 is an exploded view of an electric curtain in accordance with a first preferred embodiment of the present invention;

FIG. 2 is a perspective view of an electric curtain in accordance with the first preferred embodiment of the present invention;

FIG. 3 is a front view of an electric curtain of the present invention as depicted in FIG. 2;

FIG. 4 is a cross-sectional top view of an electric curtain in accordance with the first preferred embodiment of the present invention;

FIG. 5 is a front view of an electric curtain in accordance with a second preferred embodiment of the present invention; and

FIG. 6 is a perspective view of an electric curtain in accordance with a third preferred embodiment of the present invention.

### DESCRIPTION OF THE PREFERRED EMBODIMENTS

The technical contents of the present invention will become apparent with the detailed description of preferred embodiments accompanied with the illustration of related drawings as follows. It is noteworthy that same numerals are used for representing same respective elements in the drawings.

The present invention provides an electric curtain with a hiding mechanism, and the curtain is installed to an inner wall of a window of a building and provided for controlling, opening, and shutting a curtain body (or covering the window).

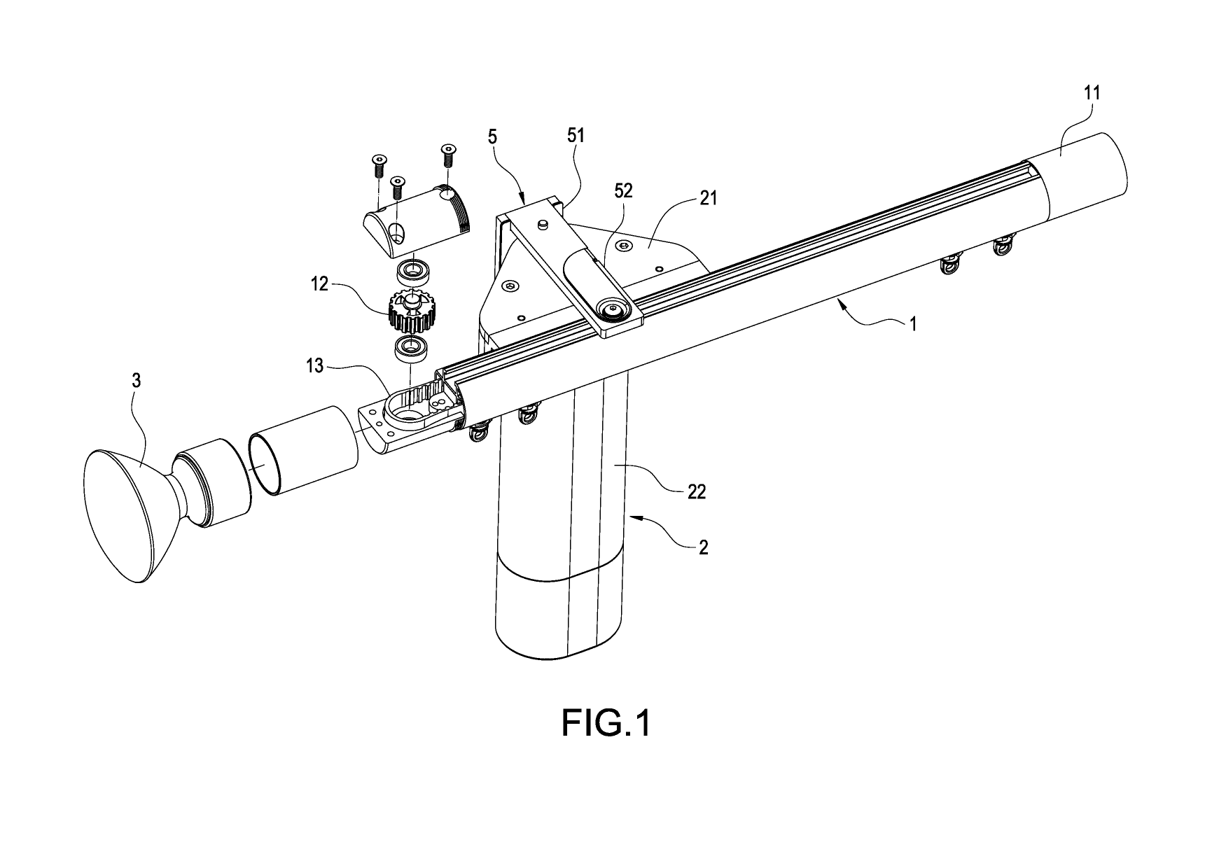

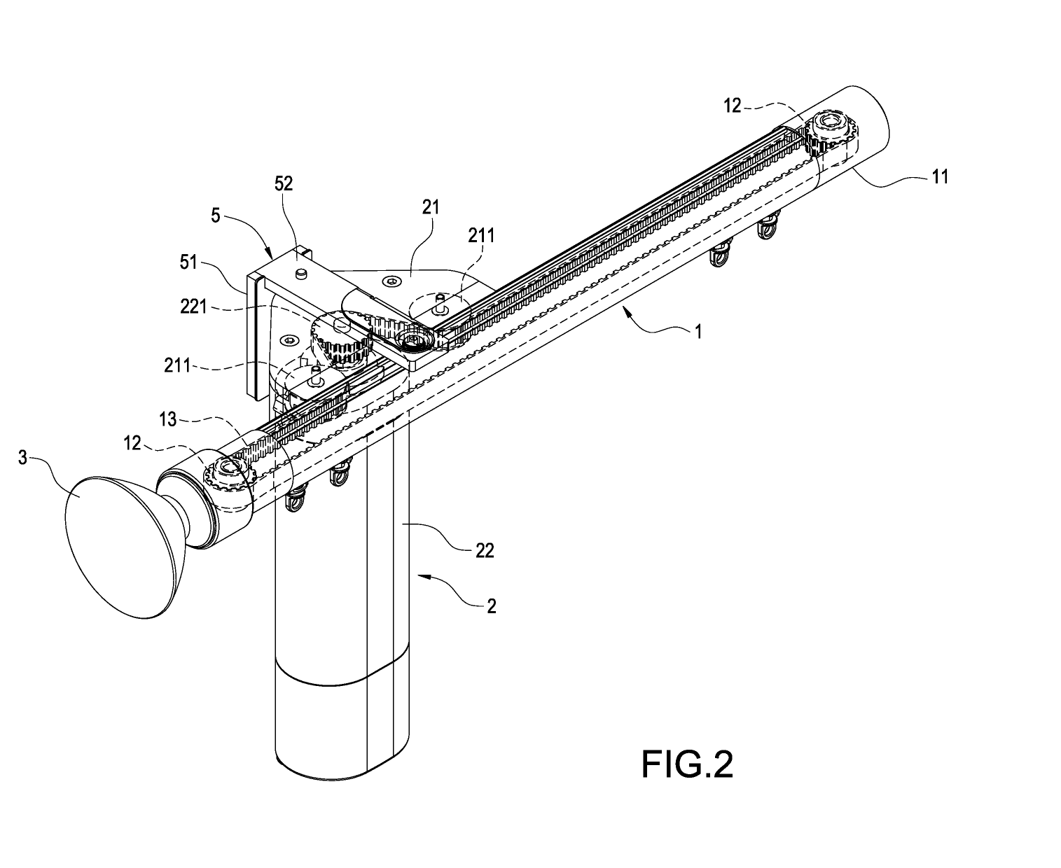

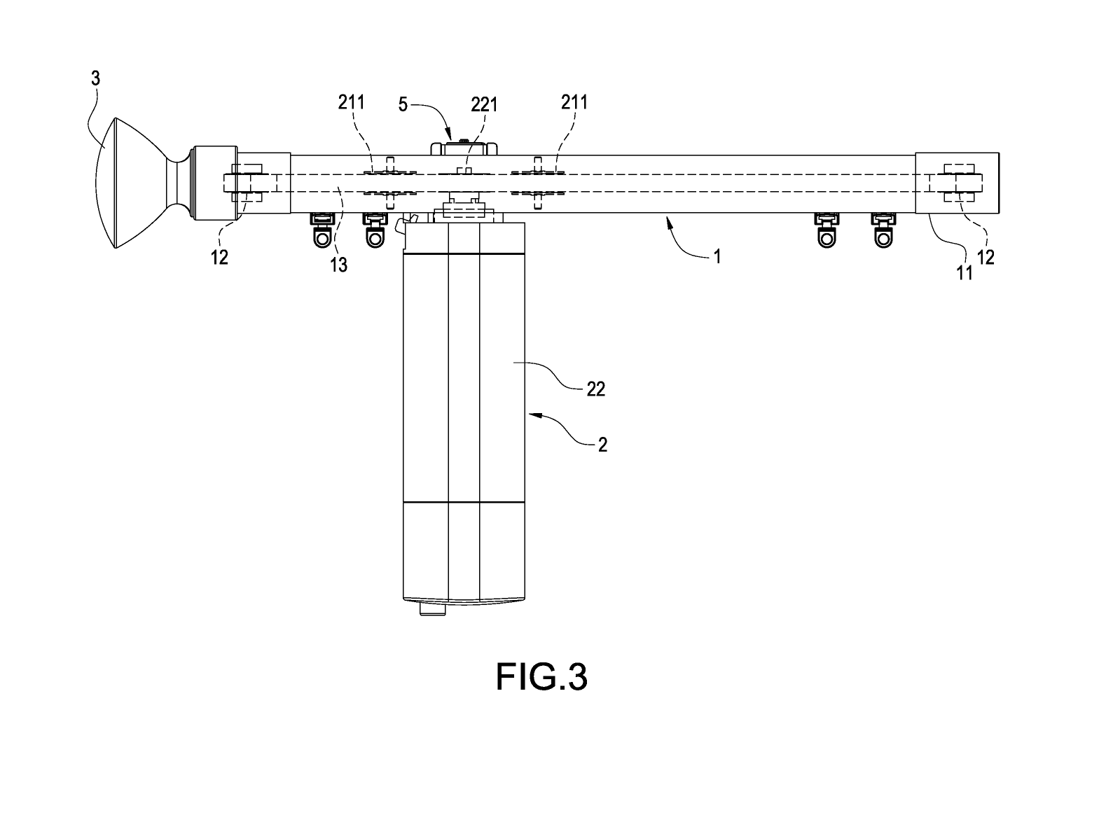

With reference to FIGS. 1 to 4 for an electric curtain in accordance with the first preferred embodiment of the present invention, the electric curtain comprises a curtain rod 1 and a driving device 2.

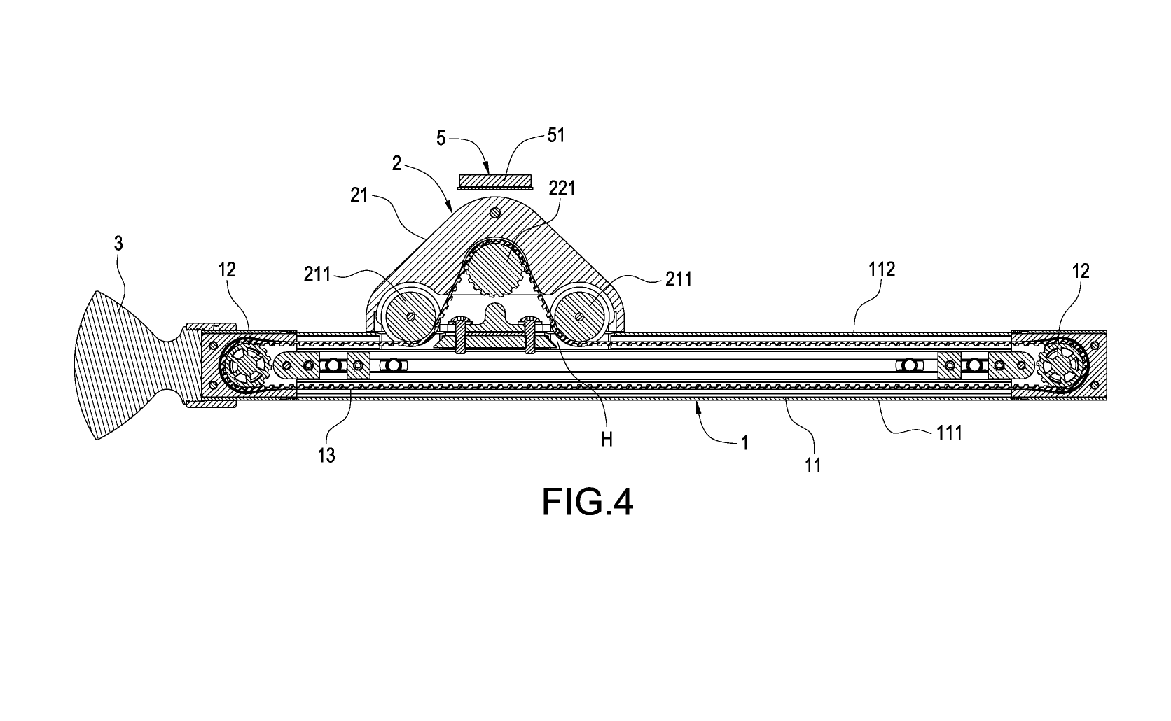

The curtain rod 1 with a front side 111 and a back side 112 opposite to each other (as shown in FIG. 4) includes a housing 11 and at least two driven wheels 12 and a belt 13 installed in the housing 11, wherein there are driven wheels 12, and the following example uses two driven wheels 12 to illustrate the present invention. The two driven wheels 12 are respectively and pivotally coupled to both ends of the housing 11, and the belt 13 is wound around the two driven wheels 12 in the housing 11 and driven by a driving device 2. The curtain body (not shown in the figure) is installed to the curtain rod 1 and driven by the belt 13 to open or shut the curtain.

The driving device 2 is installed to a back side 112 of the curtain rod 1 (as shown in FIG. 4) and hidden by the curtain body (not shown in the figure) disposed below the curtain rod 1.

Specifically, the driving device 2 includes a linker 21 and a driving machine 22. The driving machine 22 is installed at the bottom side of the linker 21, and a driving wheel 221 of the driving machine 22 is extended into the linker 21. The linker 21 is coupled to the of the curtain rod 1, and opening H is formed and interconnected between the linker 21 and the housing 11 of the curtain rod 1 (as shown in FIG. 4), and the belt 13 is passed through the opening H and wound around the driving wheel 221, so that the driving machine 22 can pass through the driving wheel 221 to drive the belt 13 to move.

In this preferred embodiment, the driving device 2 further includes at least two idle wheels 211 pivotally coupled to the interior of the linker 21, and the belt 13 is passed through the opening H and wound around the at least two idle wheels 211 to drive the belt 13 smoothly, so as to drive the electric curtain more smoothly and quietly.

In FIG. 4, the at least two idle wheels 211 are installed on two opposite sides of the driving wheel 221, wherein there are idle wheels 211, and this example uses two idle wheels 211 to illustrate the present invention, so that the belt 13 can be sequentially and circularly wound around the driving wheel 221, one of the two idle wheels 211, two driven wheels 12 and the other one of the two idle wheels 211.

In FIGS. 1 to 4, the electric curtain in accordance with the first preferred embodiment of the present invention further comprises at least one decorative element 3 installed at one end or both ends of the curtain rod 1 for the purpose of decoration to make the electric curtain of the present invention look more beautiful.

In FIGS. 1 to 4, the electric curtain in accordance with the first preferred embodiment of the present invention further comprises at least one frame 5, each including a fixing part 51 and a hanging part 52 coupled to each other, and the fixing part 51 is fixed to the inner wall, and the hanging part 52 is coupled to the curtain rod 1, so as to connect the frame 5 between the curtain rod 1 and the inner wall of the window of the building. In other words, the electric curtain of the present invention is installed to an inner wall of the window of the building and further provided for controlling the curtain body (not shown in the figure) to open or shut the window.

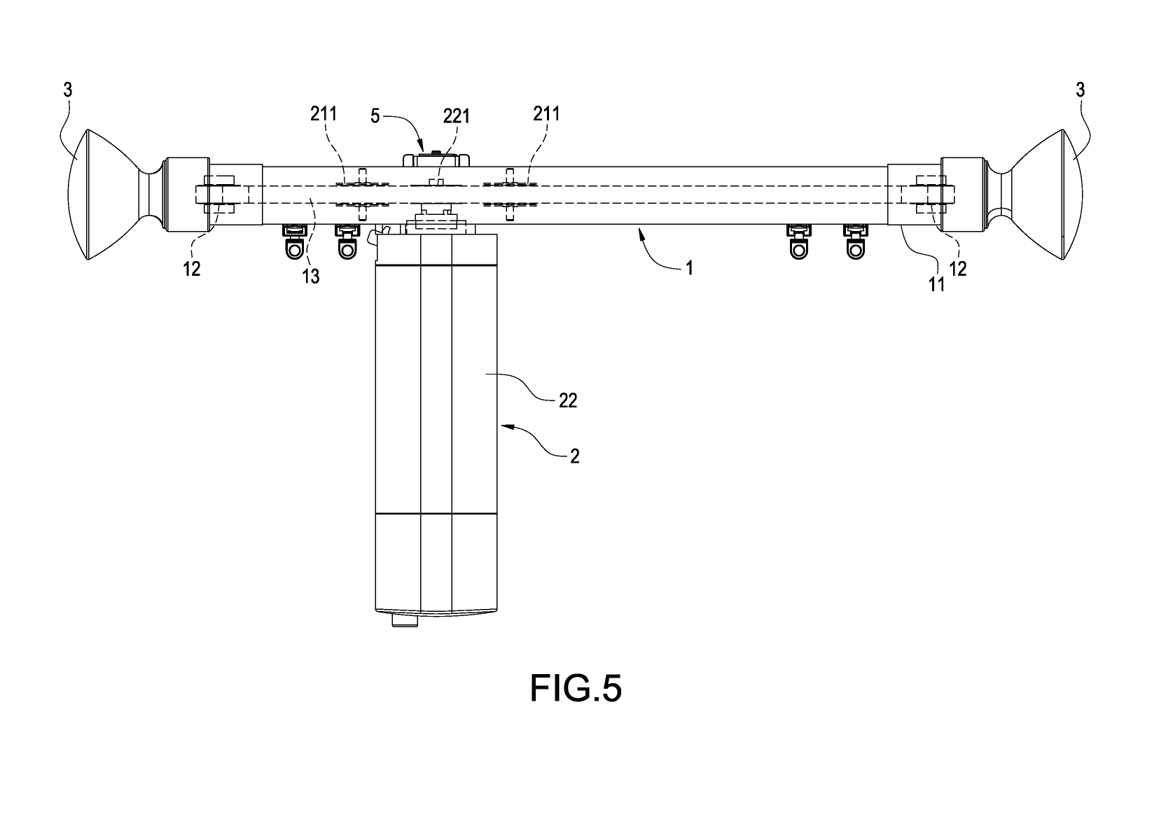

With reference to FIG. 5 for an electric curtain in accordance with the second preferred embodiment of the present invention, the second preferred embodiment is substantially the same as the first preferred embodiment, except that both ends of the curtain rod 1 of the second preferred embodiment have the decorative elements 3 to improve the overall appearance of the electric curtain.

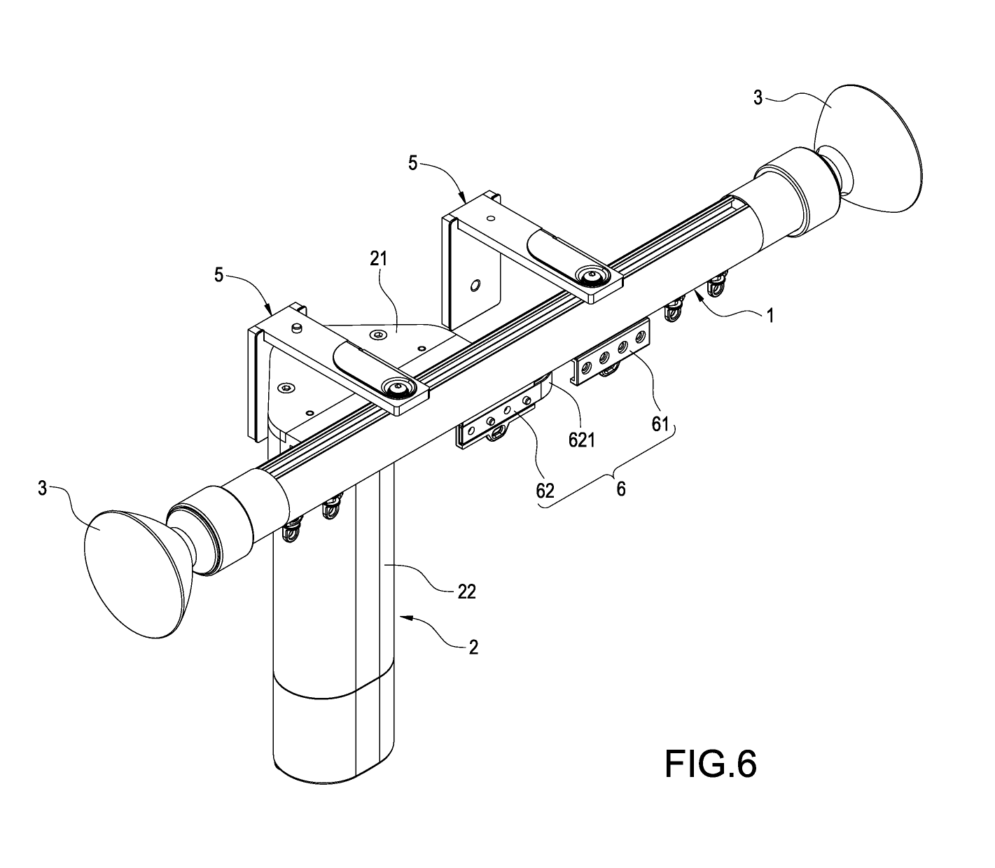

With reference to FIG. 6 for an electric curtain in accordance with the third preferred embodiment of the present invention, the third preferred embodiment is substantially the same as the second preferred embodiment, except that the third preferred embodiment further includes an overlapping mechanism 6, and plural frames 5 are used to support the curtain rod 1.

The overlapping mechanism 6 is driven by a first driving element 61 and a second driving element 62 of the belt 13, and one of the two ends of the second driving element 62 proximate to the first driving element 61 has a making-way portion 621, wherein the making-way portion 621 of this preferred embodiment is in an arc shape and provided for making way for the other adjacent end of the two ends of the first driving element 61 proximate to the second driving element 62 to facilitate the second driving element 62 to move to the rear of the first driving element 61, such that the first driving element 61 and the second driving element 62 can be overlapped.

The first driving element 61 and the second driving element 62 are coupled to the top of two adjacent sides of the curtain body (not shown in the figure) respectively, so that when the curtain body is driven to cover the window, two adjacent sides of the curtain body are close to each other, and the first driving element 61 and the second driving element 62 are provided for driving the two adjacent sides of the curtain body to overlap each other, so that there will be no gap between the two adjacent sides of the curtain body.

Compared with the prior art, the present invention has the following effects: The ugly driving device 2 is installed at the back side 112 of the curtain rod 1, so that the driving device 2 can be covered by the curtain body and hidden to improve the overall appearance of the electric curtain. In addition, the idle wheel 211 is added and wound by the belt 13 to achieve the effect of driving the belt 13 smoothly, so that the electric curtain of the present invention can be driven more smoothly and quietly.

In addition, the present invention further has other effects: A decorative element 3 is installed to at least one end of the curtain rod 1 to improve the aesthetic appearance. An overlapping mechanism 6 is added to the curtain rod 1, so that there will be no gap between the two adjacent sides of the curtain body.

While the invention has been described by means of specific embodiments, numerous modifications and variations could be made thereto by those skilled in the art without departing from the scope and spirit of the invention set forth in the claims.

What is claimed is:

1. An electric curtain with a hiding mechanism, for driving a curtain body (not shown in the figure), and the electric curtain comprising:
a curtain rod (1), with a front side (111) and a back side (112), including at least two driven wheels (12) installed in the curtain rod (1) and a belt (13) wound around the at least two driven wheels (12), and the curtain body being installed to the curtain rod (1) and driven by the belt (13); and
a driving device (2), installed at the back side (112) of the curtain rod (1) and hidden by the curtain body, for driving the belt (13) to move.

2. The electric curtain with a hiding mechanism as claimed in claim 1, wherein the driving device (2) includes a linker (21) coupled to the back side (112) of the curtain rod (1) and a driving machine (22) installed to the linker (21), and an opening (H) formed and interconnected between the linker (21) and the interior of the curtain rod (1), and the driving machine (22) has a driving wheel (221) extended into the linker (21), and the belt (13) is passed through the opening (H) and wound around the driving wheel (221) so as to be driven by the driving wheel (221).

3. The electric curtain with a hiding mechanism as claimed in claim 2, wherein the driving device (2) further includes at least two idle wheels (211) pivotally coupled into the linker (21), and installed on both opposite sides of the driving wheel (221) respectively, and the belt (13) is wound around the at least two idle wheels (211).

4. The electric curtain with a hiding mechanism as claimed in claim 3, wherein both of the idle wheels (211) and the driven wheels (12) come with a quantity of two, and the belt (13) is sequentially wound around the driving wheel (221), one of the two idle wheels (211), the two driven wheels (12) and the other one of the two idle wheels (211).

5. The electric curtain with a hiding mechanism as claimed in claim 1, wherein the curtain rod (1) includes a housing (11), and the at least two driven wheels (12) are pivotally coupled into both ends of the housing (11), and the belt (13) is disposed in the housing (11) and wound around the at least two driven wheels (12) and driven by the driving device (2).

6. The electric curtain with a hiding mechanism as claimed in claim 1, further comprising at least one decorative element (3) installed to at least one of the two ends of the curtain rod (1).

7. The electric curtain with a hiding mechanism as claimed in claim 1, further comprising at least one frame (5) coupled between the curtain rod (1) and an inner wall (not shown in the figure) of a building (not shown in the figure).

8. The electric curtain with a hiding mechanism as claimed in claim 7, wherein the at least one frame (5) includes a fixing part (51) and a hanging part (52) coupled to each other, and the fixing part (51) is fixed to the inner wall, and the hanging part (52) is coupled to the curtain rod (1).
